(19) United States
(12) Patent Application Publication
(10) Pub. No.: US 2026/0121540 A1
(43) Pub. Date: Apr. 30, 2026

(54) STATUS REPORT OF POWER STAGE CIRCUIT FOR MULTIPHASE VOLTAGE REGULATOR

(71) Applicant: Monolithic Power Systems, Inc., Kirkland, WA (US)

(72) Inventors: Cheng-Dong Lee, New Taipei City (TW); Shih-An Wang, Taoyuan City (TW); Ting-Hung Wang, Taipei City (TW); Chun-Shih Huang, New Taipei City (TW); Yi-Peng Lin, New Taipei City (TW)

(21) Appl. No.: 18/926,218

(22) Filed: Oct. 24, 2024

(51) Int. Cl. H02M 3/158; H02M 1/088

(52) U.S. Cl. CPC H02M 3/1586; H02M 1/088

(57) ABSTRACT

A control circuit for a multiphase voltage regulator is provided. The control circuit includes a switching control circuit, and a monitor circuit. The switching control circuit is configured to provide a plurality of control signals to control a plurality of power stage circuits. The monitor circuit is configured to receive a report signal from at least one of the power stage circuits, and determine whether the report signal indicates the corresponding power stage circuit is ready to be powered on. After the report signal indicates that the corresponding power stage circuit is ready to be powered on, the control signal is provided to power on the corresponding power stage circuit.

### TECHNICAL FIELD

The present disclosure relates generally to power circuits, and more particularly but not exclusively to multiphase voltage regulators.

### BACKGROUND OF THE INVENTION

Multiphase voltage regulator has been widely used in high power applications. The multiphase voltage regulator includes multiple (e.g., n) power stage circuits, where n is a positive integer greater than 1. Specifically, the n power stage circuits are coupled in parallel, and each of the power stage circuit to provide a higher output current to the load. Each power stage circuits is configured to share the input voltage and the output voltage and provide a phase current to a load. In one embodiment, the n power stage circuits are interleaved in n phases to reduce current ripple at the input and output and improve efficiency. Typically, each of the n power stage circuits is an integrated circuit (IC), and a multiphase controller is also an IC configured to provide the n phase control signals to respectively control the n power stage ICs. Therefore, it is important for the multiphase controller IC to monitor the status of the power stage ICs to provide the regulated output voltage. For example, when a fault evet is triggered, the power stage IC report the fault status to the multiphase controller IC so that the multiphase controller IC controls the power stage IC to stop operation. However, during the start-up period, that is, before the power stage IC operates, the reporting circuit may not operate normally, and thus the status of the power stage ICs may be unknown for the multiphase controller IC. As a result, it is desirable to provide the status report of power stage IC during start-up.

### SUMMARY OF THE INVENTION

According to an embodiment of the present disclosure, a control circuit for a multiphase voltage regulator is provided. The control circuit includes a switching control circuit, and a monitor circuit. The switching control circuit is configured to provide a plurality of control signals to control a plurality of power stage circuits. The monitor circuit is configured to receive a report signal from at least one of the power stage circuits, and determine whether the report signal indicates the corresponding power stage circuit is ready to be powered on. After the report signal indicates that the corresponding power stage circuit is ready to be powered on, the control signal is provided to power on the corresponding power stage circuit.

According to another embodiment of the present disclosure, a power stage circuit is provided. The power stage circuit includes a first power switch, a second power switch, a driving control circuit, and a report circuit. The first power switch has a first terminal, a second terminal and a third terminal. The first terminal of the first power switch is configured to receive an input voltage. The second power switch has a first terminal, a second terminal and a third terminal. The first terminal of the second power switch is coupled to the second terminal of the first power switch, and the second terminal of the second power switch is configured to be coupled to a reference voltage level. The driving control circuit is configured to receive a control signal and provide a first driving signal to the control terminal of the first power switch and provide a second driving signal to the control terminal of the second power switch. The report circuit is configured to issue a report signal indicating the power stage circuit is ready to be powered on.

According to yet another embodiment of the present disclosure, a multiphase voltage regulator is provided. The multiphase voltage regulator includes a plurality of power stage circuits and a control circuit coupled to the power stage circuits. Each of the power stage circuits is configured to provide a phase current to a load. Each power stage circuit includes at least one power switch and a report circuit. The report circuit is configured to provide a report signal. The control circuit is configured to receive the report signal from at least one of the power stage circuits, determine whether the report signal indicates the corresponding power stage circuit is ready to be powered on; and provide a plurality of control signals to the power stage circuits after it is determined that the report signal indicates the corresponding power stage circuit is ready to be powered on.

According to yet another embodiment of the present disclosure, a method for controlling a multiphase voltage regulator is provided. The method includes the following actions. A report signal is received from at least one of a plurality of power stage circuits. Whether the report signal indicates that the corresponding power stage circuit is ready is determined. A control signal is provided to power on the corresponding power stage circuit after the report signal indicates the corresponding power stage circuit is ready to be powered on.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 is a schematic block diagram of a multiphase voltage regulator in accordance with an embodiment of the present disclosure.

FIG. 2 is a schematic block diagram of a multiphase controller IC in accordance with an embodiment of the present disclosure.

FIG. 3 is a schematic block diagram of a power stage IC in accordance with an embodiment of the present disclosure.

FIG. 4A shows a power on sequence of a multiphase voltage regulator having a multiphase controller IC and multiple power stage ICs.

FIG. 4B shows a fault event of a multiphase voltage regulator triggered by incorrect power sequence.

FIG. 5 is a power on sequence of a multiphase voltage regulator in accordance with one embodiment of the present disclosure.

FIG. 6 is a schematic circuit diagram of a multiphase voltage regulator in accordance with one embodiment of the present disclosure.

FIG. 7 is a schematic circuit diagram of a multiphase voltage regulator in accordance with another embodiment of the present disclosure.

FIG. 8 is a schematic circuit diagram of a multiphase voltage regulator in accordance with yet another embodiment of the present disclosure.

FIG. 9 is a flowchart of a method for controlling a multiphase voltage regulator in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

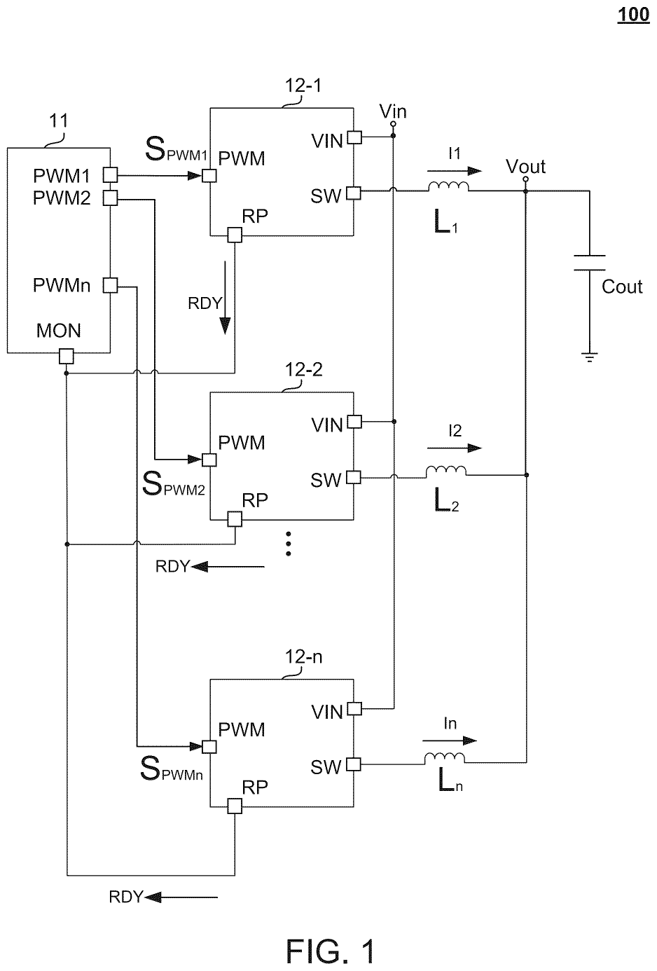

FIG. 1 is a schematic block diagram of a multiphase voltage regulator 100 in accordance with an embodiment of the present disclosure. The multiphase voltage regulator 100 includes a control circuit 11 and multiple (e.g., n) power stage circuits 12-1 to 12-n, where n is a positive integer greater than 1. The n power stage circuits are coupled in parallel, and each of the power stage circuit to provide a higher output current to the load. Each power stage circuits is configured to share the input voltage Vin and the output voltage Vout and provide a phase current (e.g., I1, I2, . . . , In) to a load. In one embodiment, the n power stage circuits are interleaved in n phases to reduce current ripple at the input and output and improve efficiency. The control circuit 11 is configured to provide the n phase control signals (e.g., S_{PWM1}, S_{PWM2}, . . . , S_{PWMn}) to respectively control the n power stage circuits.

In one implementation, the multiphase voltage regulator 100 is a multiphase buck converter. However, the present disclosure is not limited thereto. The multiphase voltage regulator 100 may be a multiphase boost converter, a trans-inductor voltage regulator (TLVR), a multiphase DC-DC converters, or any multiphase converters. In some implementations, the multiphase voltage regulator 100 is an isolated converter. In some other implementations, the multiphase voltage regulator 100 is a non-isolated converter.

In one embodiment, the control circuit 11 is a multiphase controller integrated circuit (IC) having n switching control pins (e.g., PWM1-PWMn) and a monitor pin (e.g., MON). In one embodiment, each of the power stage circuits 12-1 to 12-n is an IC. Each of the power stage circuits 12-1 to 12-n includes a VIN pin configured to receive the input voltage Vin, a SW pin configured to provide the output voltage Vout via the inductor (e.g., L₁, L₂, . . . , Lₙ), a switching control pin (e.g., PWM) configured to receive the control signals (e.g., S_{PWM1}, S_{PWM2}, . . . , S_{PWMn}) from the multiphase controller IC 11, and a report pin (e.g., RP) configured to transmit a report signal (e.g., RDY) to the multiphase controller IC 11. The report signal indicates whether the power stage circuit is ready to be powered on.

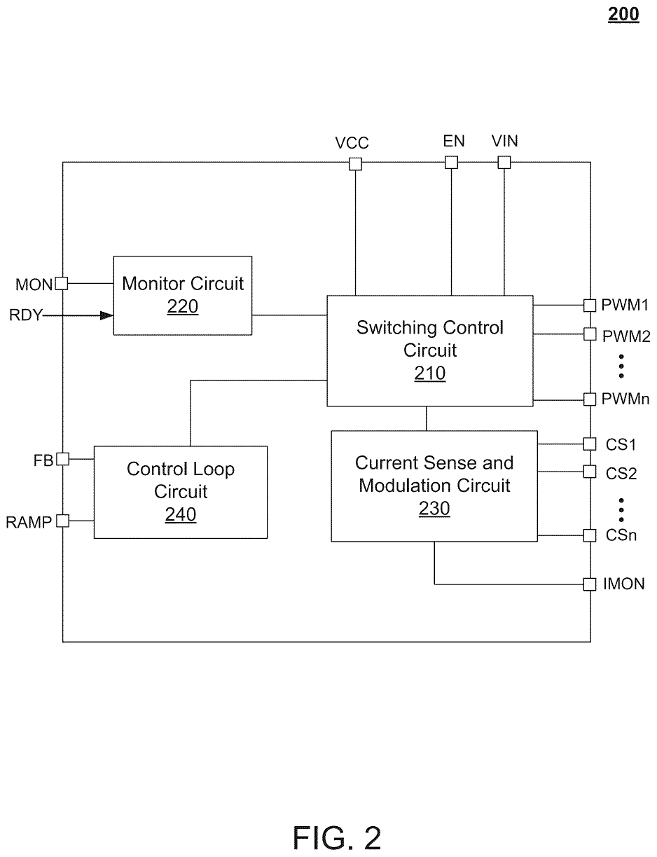

FIG. 2 is a schematic block diagram of a multiphase controller IC 200 in accordance with an embodiment of the present disclosure. The multiphase controller IC 200 includes a switching control circuit 210, and a monitor circuit 220. The switching control circuit 210 is configured to provide control signals via the switching control pins (e.g., PWM1, PWM2, . . . , PWMn) to control the power stage circuits. The monitor circuit 220 is configured to receive a report signal (e.g., RDY) via the monitor pin (e.g., MON), and determine whether the report signal RDY indicates the power stage circuit is ready to be powered on. In one embodiment, the monitor pin MON is configured to receive the status of one of the power stage circuits, and the report signal RDY is received via the monitor pin MON. For example, the status of the power stage circuit indicates a fault event or a warning. The fault event may include, but not limited to, Vin over voltage protection (OVP), Vin under voltage lockout (UVLO), over current protection (OCP), under current protection (UCP), over temperature protection (OCP), a phase current limit, Vout OVP, Vout UVLO, and Vout reverse voltage protection (RVP). In one implementation, different voltage levels of the monitor pin MON are configured to indicate different fault events or warnings, and whether the power stage circuit is ready to be powered on. In some implementations, the report signal RDY is a digital signal configured to represent various fault types, warning and whether the power stage circuit is ready to be powered on. Accordingly, the monitor circuit 220 is configured to receive a report signal RDY via the monitor pin MON, and determine whether the report signal RDY indicates the power stage circuit is ready to be powered on.

In one embodiment, the multiphase controller IC 200 further includes a current sense and modulation circuit configured to receive current sense signals indicating the respective phase currents of the power stage circuits via the current sense pin (e.g., CS1, CS2, . . . , CSn). In one embodiment, the current sense signals are used to provide a total load current sense signal via the pin IMON.

In one embodiment, the multiphase controller IC 200 further includes a control loop circuit 240 configured to regulate the output voltage Vout. For example, the control loop circuit 240 sense the feedback voltage via the feedback pin FB. The feedback voltage represents the output voltage Vout. In one embodiment, the feedback voltage is compared with a reference signal to generate a compensation signal (e.g., via an error amplifier EA), and the compensation signal is compared with a ramp signal received via the pin RAMP to generate a control signal (e.g., via a PWM comparator). In another embodiment, the feedback voltage is compared with a reference signal to generate a compensation signal (e.g., via an error amplifier EA), and the compensation signal is compared with the inductor current to generate the control signal (e.g., via a PWM comparator). In yet another embodiment, the feedback voltage is compared with a reference signal to generate a compensation signal (e.g., via a PWM comparator), and the control signal is generated in response to the compensation signal and an on-time.

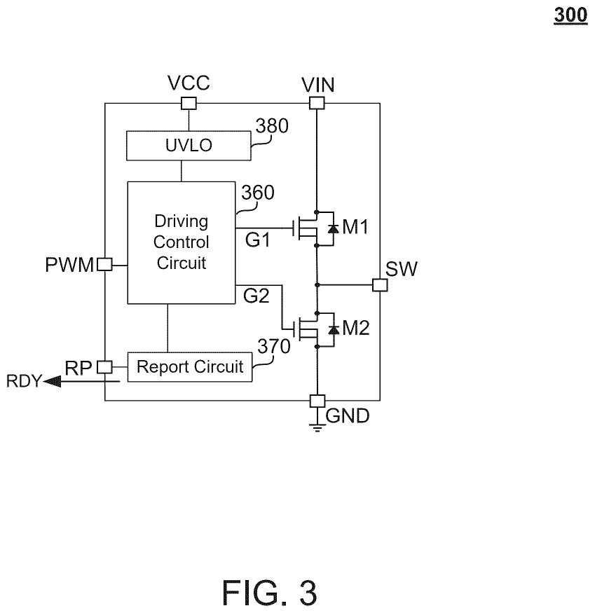

FIG. 3 is a schematic block diagram of a power stage IC 300 in accordance with an embodiment of the present disclosure. The power stage IC 300 includes two power switches M1 and M2, a driving control circuit 360, and a report circuit 370. In one implementation, the power switches M1 and M2 are n-type Metal-Oxide-Semiconductor Field-Effect Transistor (MOSFETs). The first terminal (e.g., drain) of the power switch M1 is coupled to the VIN pin configured to receive the input voltage, the second terminal (e.g., source) of the power switch M1 is coupled to the SW pin and the first terminal (e.g., drain) of the power switch M2. The second terminal (e.g., source) of the power switch M2 is coupled to the GND pin configured to be coupled to a reference voltage level (e.g., the ground). The control terminal (e.g., gate) of the power switch M1 and the control terminal (e.g., gate) of the power switch M2 are coupled to the driving control circuit 360. The driving control circuit 360 is configured to receive a control signal from the switching control pin PWM and provide the driving signals G1 and G2 to the gate terminals of the power switches M1 and M2, respectively. Specifically, the power switches M1 and M2 are turned on and turned off in response to the driving signals G1 and G2, respectively, and provide a switching signal at the SW pin. The report circuit 370 is configured to determine whether the power stage IC 300 is ready to be powered on, and issues a report signal RDY via the report pin RP when it is determined that the power stage IC 300 is ready to be powered on. In one embodiment, the report circuit 370 is coupled to a supply voltage (e.g., Vcc), and the report circuit 370 is further configured to generate the report signal RDY in response to the supply voltage (e.g., Vcc).

In one embodiment, the power stage IC 300 further includes an under voltage lockout (UVLO) circuit 230 configured to disable the operation of the driving control circuit 360 when the supply voltage (e.g., received via the VCC pin) is insufficient to protect the power stage IC 300. Therefore, in order to prevent the power stage IC 300 from malfunctioning when the supply voltage is low, the report circuit 370 detects the supply voltage and provide the report signal RDY indicating the power stage IC 300 is ready to be powered on when the supply voltage is greater than a threshold.

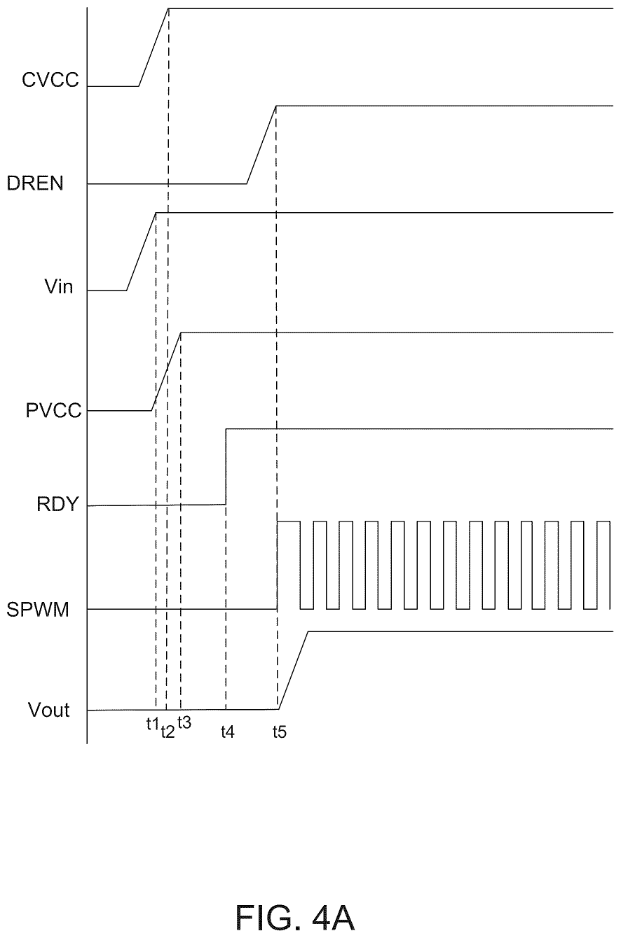

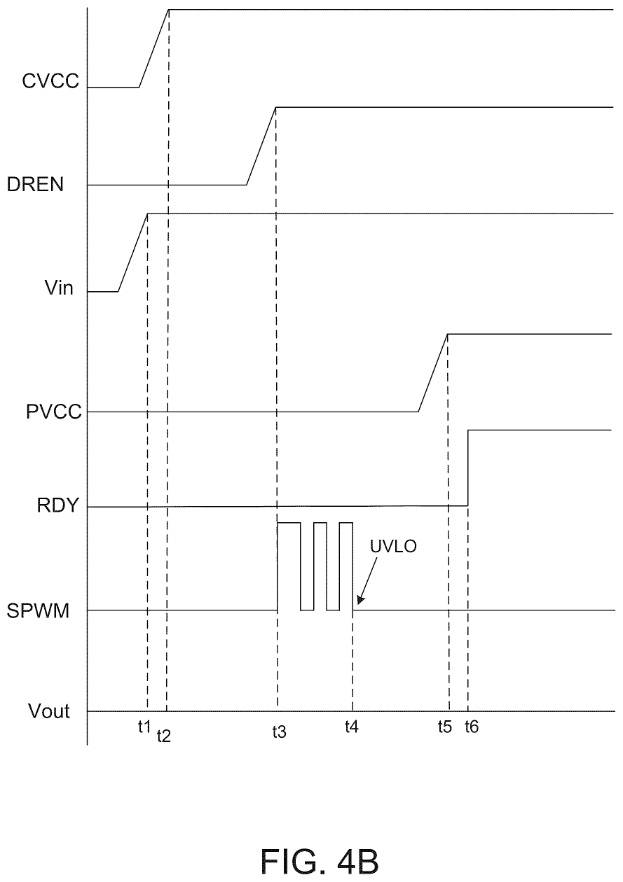

FIG. 4A shows a power on sequence of a multiphase voltage regulator having a multiphase controller IC and multiple power stage ICs. For instance, the input voltage Vin is powered on at time t1. After the supply voltage CVCC of the multiphase controller IC is powered on (e.g., transitions to a high voltage level) at time t2 and the enable signal (not shown) of the multiphase controller IC is powered on, the multiphase controller IC starts up, and enables the internal circuits. On the other hand, the supply voltage PVCC of the power stage IC is powered on at time t3. Afterwards, at time t4, after the supply voltage PVCC is ready, the report signal RDY indicates that the power stage IC 300 is ready to be powered on. Accordingly, after the power stage IC 300 is ready, when the enable signal DREN is provided to the power stage IC at time t5, the multiphase controller IC provides the control signal SPWM to the power stage IC.

It is noted that the timing control of the power on sequence of the signals are for illustration purpose only, and the timing control of the signals may be adjusted according to practical applications. For instance, as shown in FIG. 4A, the supply voltage PVCC of the power stage IC is powered on at time t3, which is after time t2, i.e. after the supply voltage CVCC of the multiphase controller IC is powered on. However, the supply voltage PVCC of the power stage IC may also be powered on before or at the same time as the supply voltage CVCC of the multiphase controller IC is powered on. Similarly, the enable signal DREN of the power stage IC, the input voltage Vin may be powered on at different time. Since the timing control of the multiphase controller IC, the power stage IC, and the supply voltage and the input voltage supplied to the multiphase controller IC and the power stage may be designed at different time, or there might be delay for signals being powered on according to practical applications, the timing control of the power on sequence for the system having a multiphase voltage regulator with the multiphase controller IC and the power stage IC is important. A fault event may triggered by the incorrect power sequence.

FIG. 4B shows a fault event of a multiphase voltage regulator triggered by incorrect power sequence. For instance, at time t3, the enable signal DREN is provided to the power stage IC. Meanwhile, the multiphase controller IC provides the control signal SPWM to the power stage IC. However, the power stage IC is not supplied with the supply voltage PVCC until time t5. As a result, the power stage IC cannot operate normally due to the insufficient supply voltage, and thus the UVLO event is triggered to shut down the power stage IC to protect the power stage IC. Meanwhile, when the multiphase controller IC detects that the output voltage Vout is below a threshold for a pre-set time, i.e., at time t4, the multiphase controller IC stop providing the control signal SPWM to the power stage IC, i.e., force the control signal SPWM to be high impedance (Hi-Z) mode to disable or turn off the power switches.

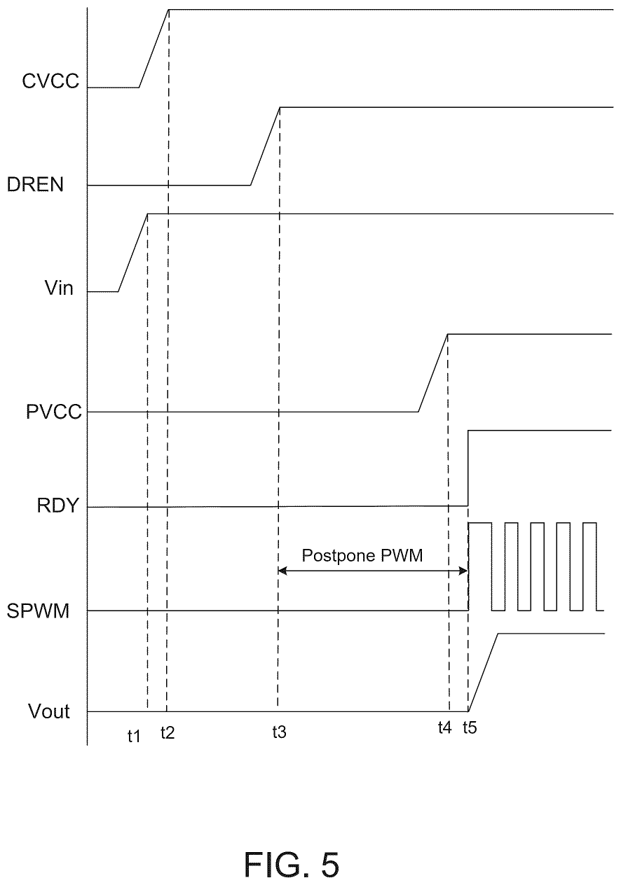

FIG. 5 is a power on sequence of a multiphase voltage regulator in accordance with one embodiment of the present disclosure. In order to prevent from the fault triggered, the multiphase controller IC will postpone PWM control and wait for the report signal RDY indicating the power stage IC is ready to be powered-on. Specifically, when the report signal RDY indicates that the power stage IC is ready to be powered-on at time t5, the multiphase controller IC starts providing the control signal SPWM to the power stage IC.

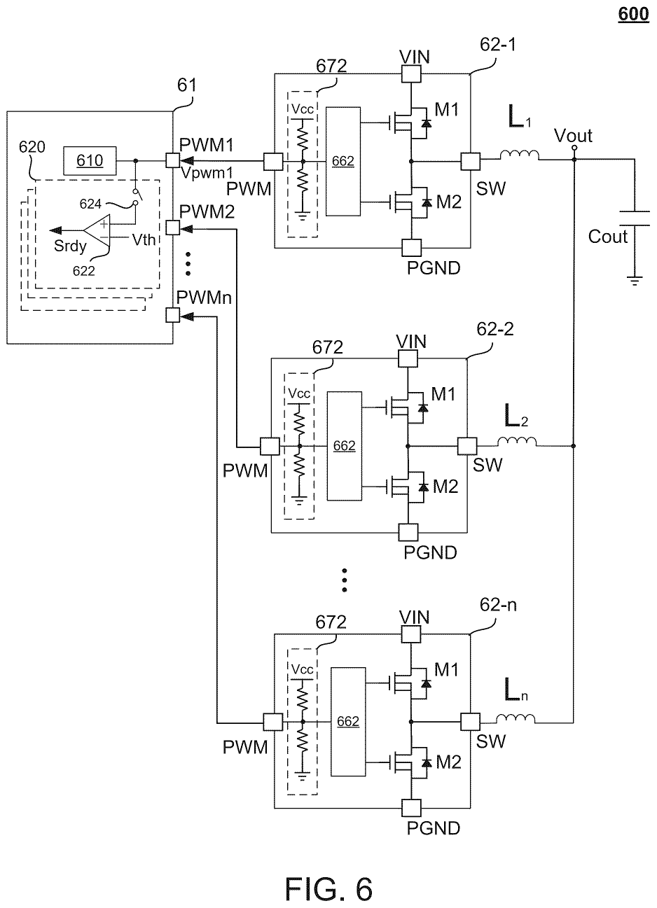

FIG. 6 is a schematic circuit diagram of a multiphase voltage regulator 600 in accordance with one embodiment of the present disclosure. In this embodiment, the report signal is realized by the voltage signal received via the switching control pin (e.g., PWMx). For instance, during an OFF state of the multiphase voltage regulator 600, that is before the multiphase voltage regulator 600 is powered on, all of the switching control pins PWM1-PWMn of the multiphase controller IC 61 are in high impedance state. Specifically, the switching control pins PWM1-PWMn are coupled to the respective switching control pin PWM of the power stage ICs 62-1 to 62-n. As shown in FIG. 6, the report circuit of each of the power stage IC 62-x includes a voltage divider (e.g., 672) coupled to the switching control pin PWM. For example, two resistors are connected between the supply voltage Vcc and the ground voltage. Therefore, the voltage of the switching control pin PWM of the power stage IC (e.g., 62-1) is at a middle voltage level, and thus the corresponding switching control pin (e.g., PWM1) of the multiphase controller IC 61 keeps in a high impedance (Hi-Z) mode (e.g., a tri-state logic level). For instance, the control signal (i.e., the voltage of the switching control pin PWM) has three states, a high logic level (e.g., 2-3.3V) to turn on the high-side switch M1, a low logic level (e.g., 0-1V) to turn on the low-side switch M2, and a tri-state logic level (e.g., 1-2V) to make the multiphase voltage regulator 600 in the Hi-Z mode (or inactive).

Accordingly, when the supply voltage Vcc is insufficient, the voltage signal Vpwm1 should also be lower than a threshold. For example, when the supply voltage Vcc is 0, the voltage signal Vpwm1 is also 0. Therefore, a comparator 622 of the monitor circuit 620 is configured to compare the voltage signal Vpwm1 with a reference voltage Vth. When it is determined that the voltage signal Vpwm1 is greater than the reference voltage Vth (e.g., 1.5V), the signal Srdy is issued, and thus the power stage IC 62-x is determined to be ready. In one implementation, when the report signal matches a middle voltage level (e.g., 1-2V), it is determined that the power stage IC 62-x is ready to be powered on. After the signal Srdy indicates the power stage IC 62-x is ready to be powered on, the switch 624 is turned off and the switching control circuit 610 provides the control signals SPWM (not shown) to the corresponding power stage IC 62-x. Accordingly, the driving control circuit 662 receives the control signal from the switching control pin PWM to control the power switches M1 and M2.

In one embodiment, there are multiple switches 624 coupled between the corresponding switching control pins PWMx of each power stage IC 62-x and the comparator 622 to determine whether each power stage IC 62-x is ready. In some embodiments, there are multiple monitor circuits 620 coupled to the corresponding switching control pins PWMx of the power stage ICs 62-x to determine whether each power stage IC is ready. In one implementation, the multiphase controller IC 61 provides the control signal SPWM to power on the corresponding power stage IC 62-x when at least one of the power stage IC is ready. In some implementations, the multiphase controller IC 61 provides the control signal SPWM to power on the corresponding power stage IC 62-x when all of the power stage ICs 62-1 to 62-n are ready.

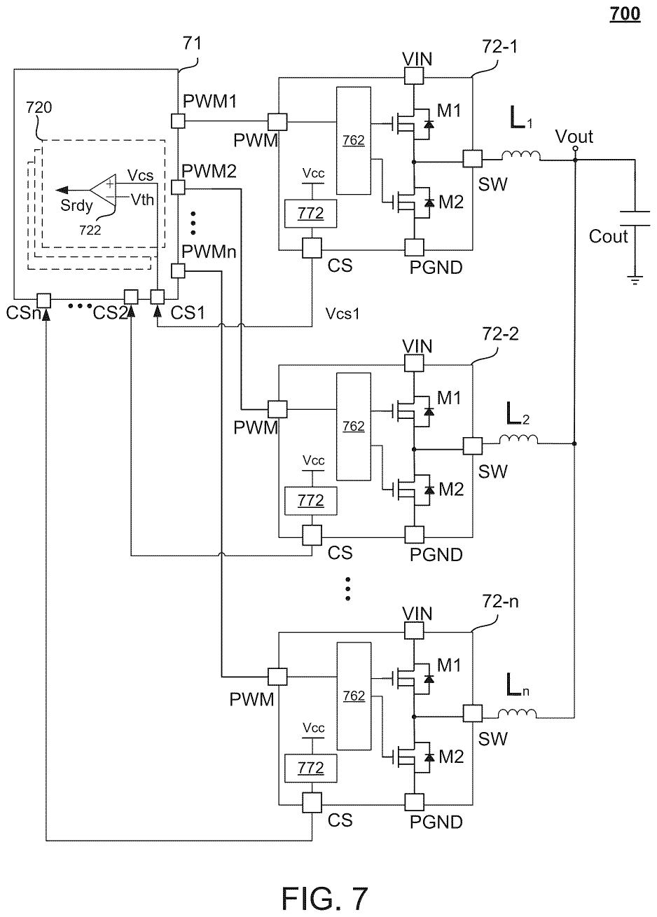

FIG. 7 is a schematic circuit diagram of a multiphase voltage regulator 700 in accordance with another embodiment of the present disclosure. In this embodiment, the report signal is realized by the current sense signal received via the current sense pins CS1 to CSn of the multiphase controller IC 71. For instance, the current sense pins CS1 to CSn of the multiphase controller IC 71 are coupled to each of the current sense pin CS of the power stage ICs 72-1 to 72-n. As shown in FIG. 7, each of the power stage IC has a report circuit 772 coupled to the supply voltage Vcc. Therefore, when the current sense signal (e.g., Vcs1) of the CS pin of the power stage IC (e.g., 72-1) matches a voltage level, the corresponding power stage IC is determined to be ready. As shown in FIG. 7, the monitor circuit 720 includes a comparator 722 configured to compare the report signal Vcs with a reference voltage Vth. When it is determined that the report signal Vcs is greater than the reference voltage Vth, the signal Srdy is issued, and thus the power stage IC 72-x is determined to be ready. After the signal Srdy indicates that the power stage IC 72-x is ready to be powered on, the control signal SPWM (not shown) is provided to the corresponding power stage IC 72-x. The driving control circuit 762 receives the control signal SPWM from the switching control pin PWM to control the power switches M1 and M2.

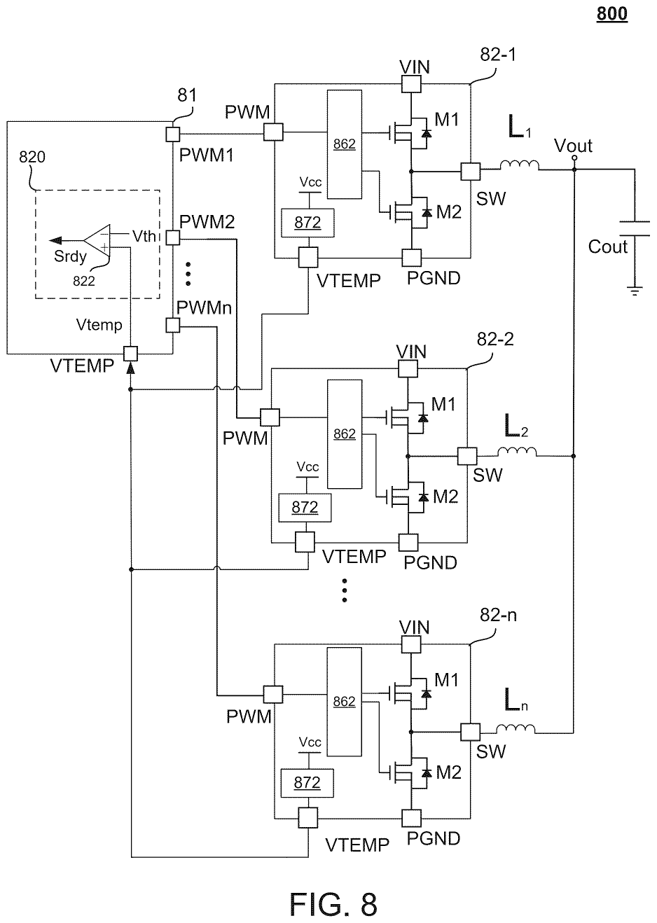

FIG. 8 is a schematic circuit diagram of a multiphase voltage regulator 800 in accordance with yet another embodiment of the present disclosure. In this embodiment, the report signal is realized by the temperature information received via the temperature report pin VTEMP of the multiphase controller IC 81. For instance, the temperature report pin VTEMP of the multiphase controller IC 81 is coupled to each of the VTEMP pin of the power stage ICs 82-1 to 82-n to receive temperature information of each power stage IC. In one embodiment, the temperature information indicates the highest temperature of the power stage IC. In another embodiment, the temperature information includes information indicating the temperature of each power stage IC. As shown in FIG. 8, each of the power stage IC has a report circuit 872 coupled to the supply voltage Vcc. As shown in FIG. 8, the monitor circuit 820 includes a comparator 822 configured to compare the voltage signal Vtemp with the reference voltage Vth. Therefore, when the report signal (e.g., Vtemp) of the power stage IC (e.g., 82-x) is greater than the reference voltage Vth, the corresponding power stage IC 82-x is determined to be ready, and the signal Srdy is issued. After the signal Srdy indicates the power stage circuit is ready to be powered on, the control signal SPWM (not shown) is provided to the corresponding power stage IC. The driving control circuit 862 receives the control signal SPWM from the switching control pin PWM to control the power switches M1 and M2.

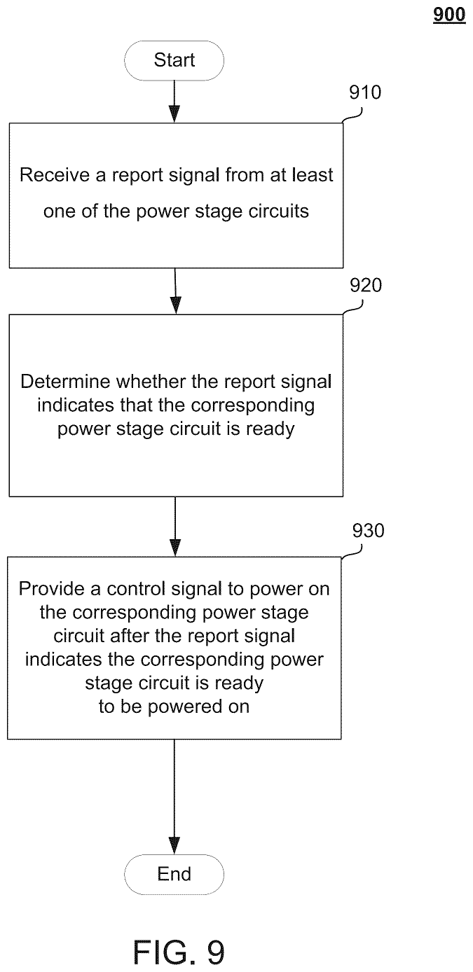

FIG. 9 is a flowchart of a method 900 for controlling a multiphase voltage regulator in accordance with one embodiment of the present disclosure. The method 900 may be performed by a multiphase controller IC 200, 61, 71, 81 as shown in FIG. 2, and 6-8. The method includes the following actions. In action 910, a report signal is received from at least one of the power stage circuits. In action 920, whether the report signal indicates that the corresponding power stage circuit is ready is determined. In action 930, a control signal is provided to power on the corresponding power stage circuit after the report signal indicates the corresponding power stage circuit is ready to be powered on.

It should be understood that, the control circuit and the related components, circuit structures, signals, and waveforms described or shown above in the present disclosure are only for illustration purpose. However, the present disclosure is not limited thereto. Persons having ordinary skill in the art may understood that the control circuit of the present disclosure could be realized, according to practical applications, by any other circuits with different circuit structures, and thus controlled by different types of the corresponding signals to achieve the corresponding functions. For example, the compensation circuit, the ramp generation circuit, the comparison circuit and the logic circuit could be realized by a digital circuit, an analog circuit, a software, an automatic generation circuit by hardware description language, or a combination of the above.

It will be appreciated by persons skilled in the art that the present disclosure is not limited to what has been particularly shown and described herein above. Rather the scope of the present disclosure is defined by the claims and includes both combinations and sub-combinations of the various features described hereinabove as well as variations and modifications thereof which would occur to persons skilled in the art upon reading the foregoing description and which are not in the prior art.

What is claimed is:

1. A control circuit for a multiphase voltage regulator, comprising:
a switching control circuit configured to provide a plurality of control signals to control a plurality of power stage circuits; and
a monitor circuit configured to receive a report signal from at least one of the power stage circuits, and determine whether the report signal indicates the corresponding power stage circuit is ready to be powered on;
wherein after the report signal indicates that the corresponding power stage circuit is ready to be powered on, the control signal is provided to power on the corresponding power stage circuit.

2. The control circuit of claim 1, wherein the monitor circuit further comprises a comparator configured to compare the report signal with a reference voltage;
and wherein the monitor circuit is configured to determine that the corresponding power stage circuit is ready to be powered on when the report signal is greater than the reference voltage.

3. The control circuit of claim 2, wherein the control circuit is an integrated circuit, further comprising:
a plurality of switching control pins, each of which is configured to provide the control signal to the corresponding power stage circuit;
wherein the switching control circuit is configured to provide the control signal with a high impedance mode to all of the switching control pins during an OFF state;
wherein a plurality of the report signals are received via the switching control pins, and the corresponding power stage circuit is determined to be ready to be powered on when the report signal matches a middle voltage level.

4. The control circuit of claim 2, wherein the control circuit is an integrated circuit, further comprising:
a plurality of current sense pins, each of which is configured to receive a current sense signal from the power stage circuit, wherein the report signals are received via the current sense pins.

5. The control circuit of claim 2, wherein the control circuit is an integrated circuit, further comprising:
a temperature report pin configured to receive temperature information of the power stage circuits; wherein the report signal is received via the temperature report pin.

6. The control circuit of claim 2, wherein the control circuit is an integrated circuit, further comprising:
a monitor pin configured to receive a status of one of the power stage circuits, wherein the report signal is received via the monitor pin.

7. A power stage circuit, comprising:
a first power switch having a first terminal, a second terminal and a third terminal, wherein the first terminal of the first power switch is configured to receive an input voltage;
a second power switch having a first terminal, a second terminal and a third terminal, wherein the first terminal of the second power switch is coupled to the second terminal of the first power switch, and the second terminal of the second power switch is configured to be coupled to a reference voltage level;
a driving control circuit configured to receive a control signal and provide a first driving signal to the control terminal of the first power switch and provide a second driving signal to the control terminal of the second power switch; and
a report circuit configured to issue a report signal indicating the power stage circuit is ready to be powered on.

8. The power stage circuit of claim 7, wherein the report circuit is coupled to a supply voltage, and the report circuit is further configured to generate the report signal in response to the supply voltage; and wherein the power stage circuit is ready to be powered on when the report signal is greater than a reference voltage.

9. The power stage circuit of claim 8, wherein the power stage circuit is an integrated circuit, further comprising:
a switching control pin configured to receive a control signal from a control circuit, wherein the switching control pin is coupled to a voltage divider to receive the supply voltage;
wherein the control signal is with a high impedance mode during an OFF state;
wherein the report signal is provided to the control circuit via the switching control pin, and the power stage circuit is ready to be powered on when the report signal matches a middle voltage level.

10. The power stage circuit of claim 8, wherein the power stage circuit is an integrated circuit, further comprising:
a current sense pin configured to provide a current sense signal to a control circuit, wherein the report signal is provided via the current sense pin.

11. The power stage circuit of claim 8, wherein the power stage circuit is an
integrated circuit, further comprising:
a temperature report pin configured to provide temperature information of the power stage circuit to a control circuit, wherein the report signal is provided via the temperature report pin.

12. The power stage circuit of claim 8, wherein the power stage circuit is an integrated circuit, further comprising:
a report pin configured to provide a status of the power stage circuit to a control circuit, wherein the report signal is provided via the report pin.

13. A multiphase voltage regulator, comprising:
a plurality of power stage circuits, each of which is configured to provide a phase current to a load, wherein each power stage circuit comprises at least one power switch and a report circuit, wherein the report circuit is configured to provide a report signal; and
a control circuit coupled to the power stage circuits;
wherein the control circuit is configured to receive the report signal from at least one of the power stage circuits, determine whether the report signal indicates the corresponding power stage circuit is ready to be powered on; and provide a plurality of control signals to the power stage circuits after it is determined that the report signal indicates the corresponding power stage circuit is ready to be powered on.

14. The multiphase voltage regulator of claim 13, wherein the control circuit further comprises a comparator configured to compare the report signal with a reference voltage; and determine that the corresponding power stage circuit is ready to be powered on when the report signal is greater than the reference voltage.

15. The multiphase voltage regulator of claim 13, wherein the control circuit is further configured to determine whether all of the report signal indicates all of the power stage circuits are ready to be powered on; and provide the control signals to the power stage circuits after it is determined that the report signals indicate that all of the power stage circuits are ready to be powered on.

16. The multiphase voltage regulator of claim 14, wherein the control circuit is an integrated circuit, further comprising:
a plurality of switching control pins, each of which is configured to provide the control signal to the corresponding power stage circuit;
wherein the control signal is with a high impedance mode during an OFF state;
wherein a plurality of the report signals are received via the switching control pins, and the corresponding power stage circuit is determined to be ready to be powered on when the report signal matches a middle voltage level.

17. The multiphase voltage regulator of claim 14, wherein the control circuit is an integrated circuit, further comprising:
a plurality of current sense pins, each of which is configured to receive a current sense signal from the power stage circuit, wherein the report signals are received via the current sense pins.

18. The multiphase voltage regulator of claim 14, wherein the control circuit is an integrated circuit, further comprising:
a temperature report pin configured to receive temperature information of the power stage circuits; wherein the report signal is received via the temperature report pin.

19. The multiphase voltage regulator of claim 14, wherein the control circuit is an integrated circuit, further comprising:
a monitor pin configured to receive a status of one of the power stage circuits, wherein the report signal is received via the monitor pin.

20. A method for controlling a multiphase voltage regulator, comprises:
receiving a report signal from at least one of a plurality of power stage circuits;
determining whether the report signal indicates that the corresponding power stage circuit is ready;
providing a control signal to power on the corresponding power stage circuit after the report signal indicates the corresponding power stage circuit is ready to be powered on.
